(19) United States
(12) Patent Application Publication
(10) Pub. No.: US 2006/0288396 A1
(43) Pub. Date: Dec. 21, 2006

(54) Adapting legacy software with an XML/XSL ISAPI

(76) Inventors: Mike Trainor, Palatine, IL (US); Carl Palmer, Streamwood, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/455,624

(22) Filed: Jun. 19, 2006

Related U.S. Application Data
(60) Provisional application No. 60/691,856, filed on Jun. 17, 2005.

(51) Int. Cl. H04N 7/173; G06F 17/00; G06F 15/00

(52) U.S. Cl. 725/113; 725/112; 725/110; 715/500.1; 715/501.1

(57) ABSTRACT

A method for translating a text based command into a multimedia format is provided. The method includes providing a the text based command to a network, converting the text based command to a URL request, providing the text based command to a text based program, translating a text based output into XML, and translating the text based XML into HTML via an XSL stylesheet.

### PRIORITY CLAIM TO RELATED APPLICATION

This application claims priority from U.S. Provisional Patent Application Ser. No. 60/691,856, filed Jun. 17, 2005, the disclosure of which is incorporated by reference in its entirety herein.

### BACKGROUND

1. Field of the Invention

The present invention relates in general to the field of software conversion, and more particularly the present invention relates to software conversion between a remote user and a content server in a medical imaging environment.

2. Background of the Invention

Users have become used to graphical user interfaces (GUI) in their lives. For example, in the 1980's users were used to typing in commands using the DOS operating system. However, Microsoft and Apple computers revolutionized the industry by providing operating systems that use GUI. GUIs are considered to be very user friendly. In addition, the use of GUIs eliminate the need to have highly specialized programmers.

In the medical field, many vendors have proprietary systems that are text based. That is, the commands are text based. Usually, if a user is in the office, the user can look up commands. However, if the user is away from the office, the user may be unable to look up commands. Thus, the user may be unable to perform the task until the user is back in the office.

Another problem with proprietary text based software is that it is not compatible with other systems. Thus, all the computers in a network require the text based software in order to communicate information.

Still another problem with proprietary text based software is that it may not be able to interface with different communication devices. For example, pocket PCs, personal digital assistants (PDAs), and cell phones are popular as communication devices. However, many proprietary text based software cannot support these mediums.

In order to rewrite text based software, the cost is prohibitive. Programmers are very expensive. In addition, testing the converted software is labor, time and cost intensive. Not many vendors can support that type of expense.

FIG. 1 discloses a text based system. A user at terminal 102 enters text based commands to perform a function e.g., performing a medical imaging function. As shown in FIG. 1, a text based query is input and a text based output is provided from the text based program 104. Therefore, the user would have to be proficient in the input as well as the expected output commands. This is an inconvenient manner of performing a task. The text based program may reside on a medical equipment such as a medical imaging system or in a communications network.

Thus, there is a need for an interface that can convert text based commands or software to a multimedia format. The interface should preferably be low cost and not labor or time intensive. The interface should preferably be able to interface with different types of communication devices.

### SUMMARY OF THE INVENTION

The above mentioned needs can be substantially accomplished by an interface that converts text based software commands to a multimedia format. The interface should preferably interface with different types of communication devices.

In at least one embodiment, the present invention takes the form of a method for translating a text based command into a multimedia format. The method includes providing a the text based command to a network, converting the text based command to a URL request, providing the text based command to a text based program, translating a text based output into XML, and translating the text based XML into HTML via an XSL stylesheet.

### BRIEF DESCRIPTION OF THE DRAWINGS

FIG. 1 is a diagram illustrating a text based medical imaging system according to the prior art;

FIG. 2A is a diagram of an exemplary system for converting a text based command to a multimedia format in accordance with an embodiment of the present invention;

FIG. 2B is a diagram illustrating an exemplary script for a style sheet in accordance with an embodiment of the present invention;

FIG. 2C is a diagram illustrating an exemplary multimedia format in accordance with an embodiment of the present invention; and

FIG. 3 is a block diagram illustrating a processing system in accordance with an embodiment of the present invention.

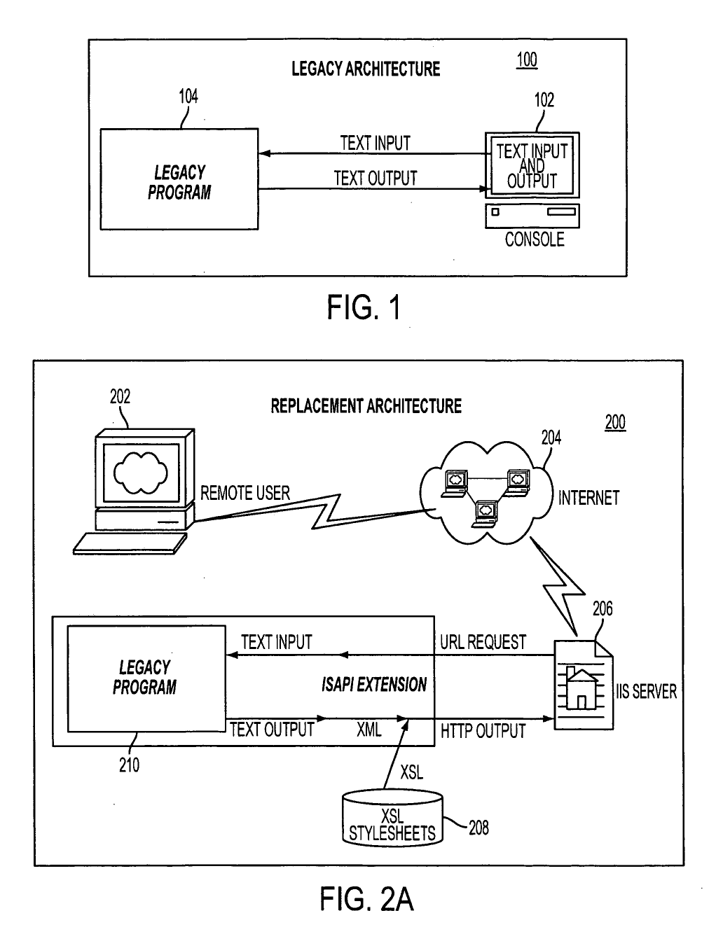

In the figures, related elements are denoted by similar element numbers.

### DETAILED DESCRIPTION OF EXEMPLARY EMBODIMENTS

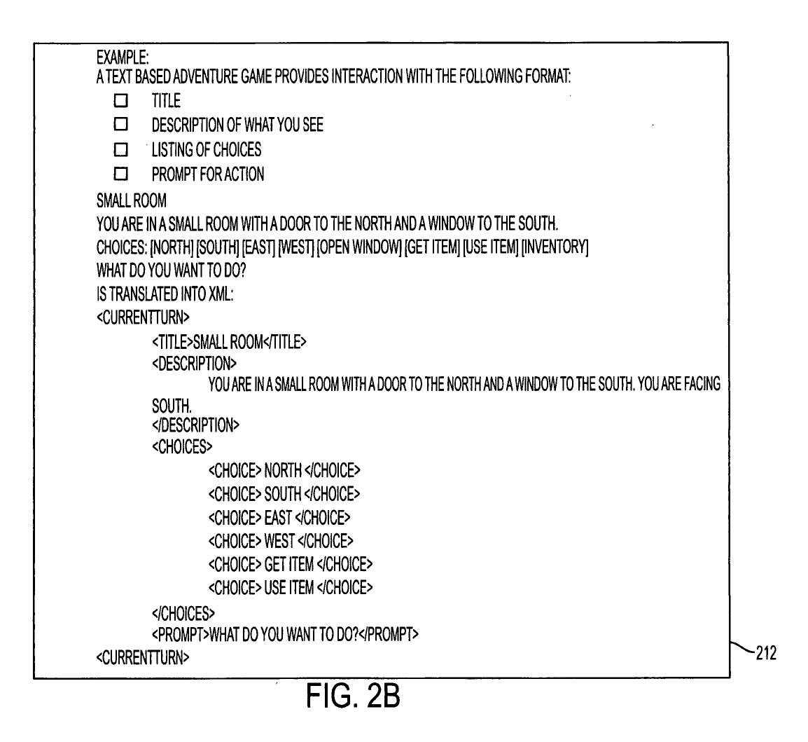

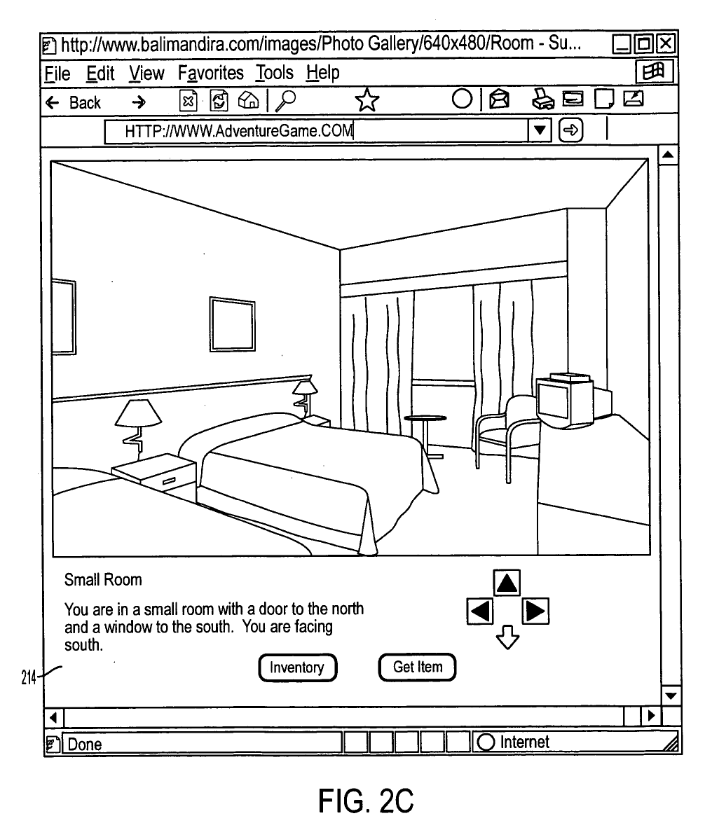

FIG. 2A is a diagram of an exemplary system for converting a text based command to a multimedia format in accordance with an embodiment of the present invention. A client device 202, such as a desktop computer, laptop computer, personal digital assistant (PDA), onboard vehicle computer, cellular telephone, and so on, transmits a text based command to a text based program 210. The text based command is routed through a network. The network may comprise a private network such as SONET ring, ATM network and the like or a public network. In this case, the network comprises a public network represented by Internet 204. The Internet 204 provides the command to a server. For illustrative purposes, an Internet Information Services (IIS) server 206 is shown.

The IIS server 206 forwards the command via a Uniform Resource Indicator (URI) such as a Uniform Resource Locator (URL). FIG. 2A shows the URL Request going to the text based program 210 as a Text input. The text based program provides a text output. However, the output text is translated into extensible markup language (XML). The XML is then translated into HyperText Markup Language (HTML), which is the standard language for creating documents on the World Wide Web (WWW). HTML defines the structure and layout of a web document by using a variety of tag commands inserted in the document to specify how the document, or portion of the document, should be formatted.

An Internet Server Application Programming Interface (ISAPI) encapsulates the text based program 210. The ISAPI handles requests for URLs from the user.

The XML translation is performed by the ISAPI extension and uses an extensible stylesheet language (XSL) to perform the translation. Using the sophisticated abilities of XSL, a style sheet can be generated that parses the XSL to provide multimedia output that is sent to the user.

FIG. 2B is a diagram illustrating an exemplary XSL script for a style sheet 212 in accordance with an embodiment of the present invention. The XSL translation is capable of parsing both the content information (e.g., “Title”) as well as the data “Small Room”. From style sheet 212. In this example, the combination of the “Small Room” title and the “facing south” string is enough information for the XSL to determine which picture is required. Specifically, the combination of the room name and the direction being faced is being used to select a background image.

FIG. 2C illustrates a multimedia format that the user will view. As shown in FIG. 2C, the XSL style sheet 212 can also parse the list of choices to determine what buttons to present to the user. When the user presses a button, the information represented by the button is appended to the URL in the standard HTTP manner. For example, if the “North” Button is selected, the URL might then be set to http://www.adventuregame.com?choice=North. This information would then be sent to the ISAPI extension that would provide this text input to the text based program 210. The resulting text output would then be caputured in XML, and the process would continue.

The text based program 210 could comprise the Legacy software by Siemens Medical Solutions. The text based program 210 may reside on a network device or on a medical imaging system. The medical imaging system may comprise at least one of a Positron Emission Tomography (PET) system, a Single Photon Emission Computed Tomography (SPECT) system and a Computed Tomography (CT) system. It should be appreciated by those skilled in the art that other combinations can be used without departing from the scope of the present invention.

In an embodiment of the present invention, the text based program 210 can be controlled using an HTTP CGI architecture. The HTTP CGI architecture can use the context of the output to determine what tags to surround the output text with. The CGI would then perform the XSL translation.

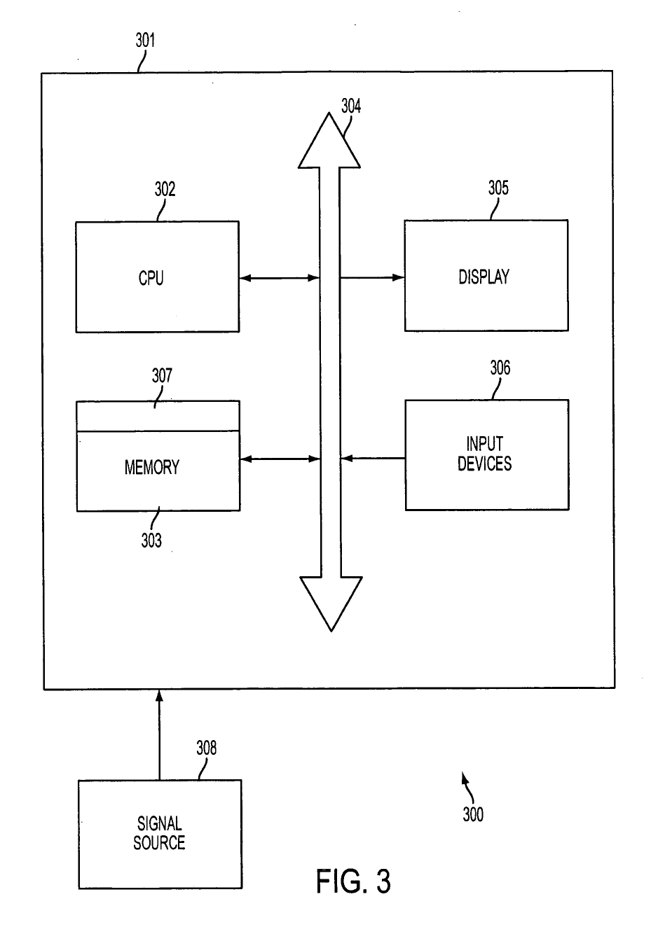

Referring now to FIG. 3, according to an embodiment of the present invention, a computer system 301 for implementing the present invention can comprise, inter alia, a central processing unit (CPU) 302, a memory 303 and an input/output (I/O) interface 304. The computer system 301 is generally coupled through the I/O interface 304 to a display 305 and various input devices 306 such as a mouse and a keyboard. The support circuits can include circuits such as cache, power supplies, clock circuits, and a communication bus. The memory 303 can include random access memory (RAM), read only memory (ROM), disk drive, tape drive, etc., or a combinations thereof. The present invention can be implemented as a routine 307 that is stored in memory 303 and executed by the CPU 302 to process the signal from the signal source 308. As such, the computer system 301 is a general purpose computer system that becomes a specific purpose computer system when executing the routine 307 of the present invention.

The computer system 301 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It should be appreciated by those skilled in the art that the process for providing a multiple view test screen can reside in the medical imaging system or in a computer attached directly or remotely to the medical imaging system.

What is claimed is:

1. A method for translating a text based command into a multimedia format comprising:
providing a the text based command to a network;
converting the text based command to a URL request;
providing the text based command to a text based program;
translating a text based output into XML; and
translating the text based XML into HTML via an XSL stylesheet.

2. The method as recited in claim 1, wherein the text based program comprises the Legacy program.

3. The method as recited in claim 1, wherein the network comprises the Internet.

4. The method as recited in claim 1, wherein the multimedia format comprises graphics, text and audio.

5. The method as recited in claim 1, wherein the network provides the text based command to an IIS server.

6. The method as recited in claim 1, wherein the text based command is transmitted from a PDA.

7. The method as recited in claim 1, wherein the text based command is transmitted from a cellular phone.

8. The method as recited in claim 1, wherein the text based command is transmitted from a laptop.

9. The method as recited in claim 1, wherein the text based program resides in a medical imaging system.

10. The method as recited in claim 9, wherein the medical imaging system comprises a SPECT.

11. The method as recited in claim 9, wherein the medical imaging system comprises a CT.

12. The method as recited in claim 9, wherein the medical imaging system comprises a PET.

13. The method of claim 1, wherein the network comprises a CGI network.
